(19) United States
(12) Patent Application Publication
(10) Pub. No.: US 2003/0074090 A1
(43) Pub. Date: Apr. 17, 2003

(54) System and method for improving operational efficiency through process automation

(76) Inventors: Zdenek Becka, Washington, DC (US); Ravi Srinath Gorur, Centerville, VA (US); Borna Safa, Sterling, VA (US); Roderick Peter Silton, Herndon, VA (US); Michael Baker Yost, Great Falls, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/073,141

(22) Filed: Feb. 13, 2002

Related U.S. Application Data
(60) Provisional application No. 60/325,195, filed on Sep. 28, 2001.
(60) Provisional application No. 60/325,218, filed on Sep. 28, 2001.
(60) Provisional application No. 60/325,194, filed on Sep. 28, 2001.

(51) Int. Cl. G05B 15/00

(52) U.S. Cl. 700/83

(57) ABSTRACT

The present invention addresses the aforementioned needs by providing a mechanism that improves operational efficiency through process automation. In one embodiment, process automation is enabled through rules that can be bound to system objects.

The present application claims priority to Provisional Application No. 60/325,195, entitled “SYSTEM AND METHOD FOR IDENTIFYING INDIVIDUALS HAVING A DESIRED SKILL SET,” filed Sep. 29, 2001, Provisional Application No. 60/325,218, entitled “SYSTEM AND METHOD FOR IMPROVING COLLABORATION BETWEEN ENTITIES IN A WORK ENVIRONMENT,” filed Sep. 29, 2001, and Provisional Application No. 60/325,194, entitled “SYSTEM AND METHOD FOR IMPROVING OPERATIONAL EFFICIENCY THROUGH PROCESS AUTOMATION,” filed Sep. 29, 2001, each of which is incorporated herein by reference in its entirety.

### CROSS-REFERENCE TO OTHER APPLICATIONS

The following applications of common assignee contain some common disclosure, and are believed to have an effective filing date identical with that of the present application.

“System and Method for Identifying Individuals Having a Desired Skill Set,” Attorney Docket No. INST001/01US, Appl. Ser. No. ______, incorporated herein by reference in its entirety.

“System an Method for Improving Management in a Work Environment,” Attorney Docket No. INST002/01US, Appl. Ser. No. ______, incorporated herein by reference in its entirety.

### BACKGROUND

1. Field of the Invention

The present invention relates generally to enterprise management, and more specifically to a system and method for improving operational efficiency through process automation.

2. Discussion of the Related Art

Operational efficiency is a key component of a successful organization. Organizations are always looking to improve their ability to produce better products and/or services with a minimum amount of operational overhead. Operational overhead is incurred any time an individual within an organization expends time and resources performing an administrative function that detracts from their primary job focus.

Many organizations have attempted to improve operational efficiency through the creation of standard processes. These standard processes improve efficiency by ensuring that the proper procedures are being followed. Significant amounts of time can be spent on creating standard processes, instructing the organization on their use, and then monitoring and managing the execution of the standard processes.

Historically, these standard processes (or “best practices”) are defined at the highest levels of the organization and are pushed down to the underlying organization members. Thus, the “best practices” are typically defined in a context that does not consider the actual needs and desires of the organization's members. Accordingly, unless required to do so, the underlying organization members will often resist adopting the “best practices.” What is needed therefore is a mechanism that enables organizations to improve operational efficiency in a flexible manner that will increase the adoption rate of standard processes within the organization.

### SUMMARY

The present invention addresses the aforementioned needs by providing a mechanism that improves operational efficiency through process automation. In one embodiment, process automation is enabled through rules that can be bound to system objects.

### BRIEF DESCRIPTION OF THE DRAWINGS

FIG. 1 is a hierarchical organization of system objects.

FIG. 2 is an illustration of the relationship between rules and event sources.

FIG. 3 is an embodiment of a rule definition user interface screen.

FIG. 4 is an embodiment of a user interface that enables binding of rules to other system objects.

FIG. 5 is an embodiment of a workflow activity domain model.

FIG. 6 is a workflow state diagram.

### DETAILED DESCRIPTION

An embodiment of the invention is discussed in detail below. While specific implementations are discussed, it should be understood that this is done for illustration purposes only. A person skilled in the relevant art will recognize that other components and configurations may be used without departing from the spirit and scope of the invention.

The implementation of standard processes has traditionally met significant resistance in its adoption within an organization. While standard processes are designed to produce uniformity and consistency within the operation of an organization, they are difficult to execute and are not typically reflective of the desires of the individuals being called upon to adopt them. More significantly, however, the burden of creating and maintaining standard processes often outweighs any potential benefit. The combination of these factors has served to reduce the speed of adoption of process automation.

To realize the true benefits of process automation, organizations need to remove barriers to the adoption of process automation. One of these barriers is the inability of process automation to grow in proportion with the needs of the organization. In that regard, process automation efforts should enable the incremental adoption (bottom-up or top-down) of automated utilities. This incremental adoption ensures that process automation is applied in the areas of greatest perceived need.

In accordance with the present invention, individual users are primarily responsible for defining their own automation tools. This flexibility enables individual users to produce automation tools that they actually desire and will be motivated to use. As will be described below, it is a feature of the present invention that automation tools can be shared amongst users, thereby enabling the creation of a vast automation tool database that can be flexibly applied to particular use scenarios.

In accordance with the present invention, automation tools are based on the concept of rules. Rules give individuals a mechanism to specify actions that can be automatically executed based on the occurrence of specified events. Examples of various actions include notifications (e.g., email), running queries, creating new system objects, etc., while examples of various events include changes in an attribute or association of a system object, expiration of a timer, external events, etc.

In one embodiment, rules are based on an event-condition-action (ECA) model. In the ECA model, occurrence of an event of interest and the satisfaction of some set of conditions, causes the execution of a set of actions. As will be described in greater detail below, the event and condition components form the scheduling part of the rule and set up the environment context necessary for performing the actions of the rule.

In general, events are things that happen in a system. Events are created by event sources. Rules listen for events of interest that occur in the system. In one embodiment, event sources include system objects that represent various items such as activities, containers, contracts, resources, and external systems.

Activities represent work within an organization. Various work-related activity objects can be defined, such as project, summary task, task, and workflow objects. A project activity is an association of activities that are focused on completing some objective. Projects do not have work associated with them directly but are the incorporation of several smaller units of work. Projects can be larger in scale and have some corporate visibility associated with them. Summary tasks are similar to projects as they represent a collection of smaller activities. Summary tasks generally do not have corporate visibility but they are used to summarize work in progress. Tasks are the smallest unit of activity and represent the building blocks of projects and summary tasks. Finally, workflow activities represent activities that have pre-defined workflows and processes associated with them. The predefined workflows can be specified in terms of workflow states, with transitions between workflow states being governed by a workflow state machine. Workflow activities are described in greater detail below.

Containers represent a group of system objects. Containers can act as a parent in a structural association (e.g., folder, project, summary task) and can take multiple children system objects. Structural associations allow containers to be used in organizing a system object repository in a hierarchical tree.

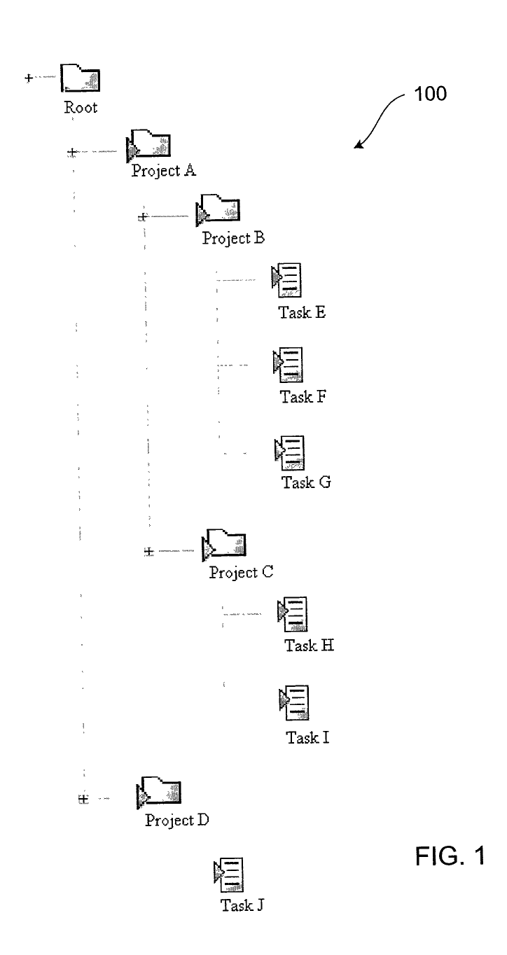

A graphical illustration of a hierarchical system object repository is provided in FIG. 1. As illustrated in system object tree 100, the Root folder includes projects A and D. Project A includes projects B and C, which further include tasks E-G and H-I, respectively. Project D further includes task J. In this example, the structural association relationship between folders, projects, and tasks enables the organization of work-related activities.

Finally, contracts represent agreements between entities within an organization. Typically, this agreement is for a first entity to deliver some product and/or service to a second entity within some time frame. The entity that delivers the product and/or service is referred to as the “provider” of a contract. The entity that is to receive the product and/or service is referred to as the “customer” of a contract. The time frame the product and/or service will be delivered is referred to as the due date of the contract. In one embodiment, the contract object can also include a Contract State attribute that identifies a state of the contract (e.g., proposed, agreed, delivered, and completed), where movement between the various contract states is governed by a contract state machine.

As thus described, activity objects, container objects, and contract objects, being examples of event sources, can be used to initiate some action that is defined by a rule. For example, a change in the expected due date of an activity, a change in the set of tasks within a project, or a change in a state of a contract can represent an event within the system that gives rise to an automated action (e.g., email notification).

In one embodiment, rules use triggers to select events of interest. Possible triggers include a system object attribute change trigger, a system object association change trigger, a timer expiration trigger, a system object delete trigger, a problem domain specific trigger, and an external event trigger.

A system object attribute change trigger selects those events that represent changes to a named attribute. The attribute change trigger would specify an attribute that is selected from a list of valid system object attribute.

A system object association change trigger selects those events that represent changes to the named association. The association change trigger would specify a named association. Examples of association changes include an association element added (e.g., new child), an association element deleted (e.g., participant removed), and an association changed (e.g., parent changed).

A timer expiration trigger allows the user to add a time driven event to any event source with which the rule is bound. The timer expiration trigger itself does not perform any timing. It does, however, contain data to provide some default information for the creation and starting of the timer at the time of binding to the event source.

Various timer expiration triggers such as an attribute-based timer and an independent timer can be defined. Attribute-based timers can be based on a time/date attribute of the event source (e.g., due date). Independent timers, on the other hand, are based on a timeout value that is entered at the time the timer expiration trigger is being created or updated. The timeout value can be independent of any event source. Independent timers may also be periodic. Independent timers can be absolute in that the date and time of expiration is fixed (e.g., Nov. 26, 2001 at 12 PM), or can be relative to the time of binding (e.g., in 3 days).

A system object delete trigger selects those events that represent deletion of the named system object.

A problem domain specific trigger supports the creation of rules based on concepts at a level higher than system object attributes. Problem domain specific triggers can provide a simpler way to build rules based on problem domain concepts. These triggers allow rules such as “Notify me when all my predecessors complete” to be created.

Finally, an external event trigger selects those events that occur outside of the system.

In general, triggers can be grouped together in a trigger set. A trigger set can have a “type” that indicates that the trigger set contains triggers that only apply to a single system object type. In other words, the set of potential triggers for a container object is different from the set of potential triggers for an activity object. Thus, a trigger set of a folder type would include only triggers suitable for a folder object.

In the ECA model, rules will evaluate its conditions when at least one trigger in a trigger set matches an event. Thus, triggers are logically OR-ed within the Trigger Set for any event.

To illustrate the role of triggers consider the example of an attribute change trigger. An attribute trigger can be defined by specifying the name of a system object attribute. Thus, an activity object attribute change trigger could specify an activity object attribute, such as the due date. Thus, if the due date attribute for the associated activity object (i.e., the event source) changes, the trigger would match. Any quantity of the potential attribute change triggers available for the particular system object type can be specified.

Timer triggers, on the other hand, indicate that the condition is to be evaluated when a timer expires. The user can set the desired timer expiration to an explicit value or to be based on one of the event source's date/time fields. Timer triggers may therefore contain some additional information to determine the desired timer expiration value.

Once an event causes one or more triggers to match, a context of the rule is set. This event context provides a system object for condition evaluation and action execution. Rule conditions use the event context to further refine whether the event is of interest.

In one embodiment, rules are constructed so that the rule contains a potential context. In other words, the rule has appropriate triggers defined for a specific event source type. For example, the rule may be defined with appropriate triggers for a task activity object. Rules are then associated with a particular event source. When the particular event source actually produces an event and the event matches the trigger, then the system object for the event source becomes the event context for the rule.

In one embodiment, the trigger framework supports listening for changes in a single type of event source and reacts to events from a single event source at a time. In this framework, a user can create a rule that may be bound to multiple event sources of a particular event source type. The rule would then respond to event sources one at a time and would not include a condition that references event contexts generated by other event sources.

Within an event context, the rule condition is evaluated against the provided system object attributes. In general, conditions permit further evaluation of the context to support increased control (filtering) of when actions should be performed. Conditions can include one or more terms that evaluate to a true or false. Terms are combined with logical operators to produce a true/false value for the entire condition. Examples of possible logical operators are illustrated in Table 1.

TABLE 1

| Operator | Operand Type |
|---|---|
| Equal | Number, enumeration, string, DateTime |
| Not Equal | Number, enumeration, string, DateTime |
| Contains | String |
| Doesn't Contain | String |
| Changed By At Least | Number, DateTime |
| Changed By Exactly | Number, DateTime |
| Changed By At Most | Number, DateTime |
| Greater Than | Number, DateTime |
| Greater Than Or | Number, DateTime |
| Equal | |
| Less Than | Number, DateTime |
| Less Than Or Equal | Number, DateTime |
| Is Type Of | System Object Type |
| Crosses Threshold | Number, DateTime |
| Increasing | |
| Crosses Threshold | Number, DateTime |
| Decreasing | |

In addition, operators for problem domain specific conditions can be defined. Examples of possible operators are illustrated in Table 2.

TABLE 2

| Name | Type | Valid Operators |
|---|---|---|
| Predecessor Percent | Number | Equal, Not Equal, Greater |
| Complete | | than, Less than |
| All predecessor's Percent | Number | Equal, Not Equal, Greater |
| Complete | | than, Less than |
| Predecessor State | Enumeration | Equal, Not Equal |
| All Predecessors' States | Enumeration | Equal, Not Equal |

If a condition is evaluated to “rue,” then the rule is considered to have matched and the actions are performed in response to the event. If the condition does not evaluate to “true,” then the rule does not match and is ignored. No actions would be performed.

In general, response actions perform one or more actions on either the system object specified in the event context or some arbitrary, a priori specified, system object.

In one embodiment, all response actions for a single rule are performed as a single transaction. If a particular command fails to execute correctly then all commands for that rule would be aborted with a log message being generated. If multiple rules exist for a single event then the response actions may be executed as separate transactions, or may be performed as a single transaction. If they are performed as a single transaction, then all response actions would follow an all succeed or all fail mode of operation.

As would be appreciated, the types of response actions that can be defined for a particular system would be implementation dependent. In one embodiment, supported response actions include Create, Update, Bind, Unbind, Copy, Execute, and Notify actions. Here, the Create action creates an instance of the specified system object, the Update action Updates an attribute of the specified system object, the Bind action binds one or more system objects to another system object, the Unbind action unbinds one or more system objects from another system object, the Copy action copies a system object, the Execute action causes the action (e.g., triggering of a rule) defined by the target system object or target external system command (e.g., execute a program) to be performed, and the Notify action sends a notification of a given type (e.g., e-mail) to one or more recipients. Details of an example syntax for these response actions are provided in Appendix A.

It should be noted that the triggering of rules by other rules could lead to a cascade of rules (or “rule storm”) being launched. This cascade may be a large finite sequence of rules or an infinite sequence of rules (e.g., a loop). Regardless, the system should have a mechanism in place to ensure that rule triggers can be canceled when the system detects a rising cascade of rules. This mechanism thereby ensures that the system will not be overwhelmed by a rule storm.

In general, actions can be both event context sensitive and event context invariant. The results of actions that are event context sensitive depend on the context in which the actions are performed. For example, a notification can be sent to the participants of THIS activity, where THIS activity is not known at rule creation time, but at rule evaluation time (i.e., when the event context is determined). Thus, if the rule is evaluated in the context of the task “Eat Lunch”, then only the participants of the task “Eat Lunch” are notified.

In general, the context sensitive nature of the rule enables rules to be flexibly applied to the various system objects that exist within the system. For example, rules can be specified with notification actions that are applicable to specific roles (e.g., project leader, quality assurance representative, etc.) that are used throughout the organization. These roles would then be resolved to particular users in the particular context to which the rule was applied.

The results of actions that are context invariant are independent of any context in which the rule may be evaluated. For example, an action of run query named “Query:/library/global reports: List all system Users” would return the same results regardless of where the action was executed.

As noted, rules can be created by individual users. Rule creation therefore enables customization of the process automation tools to the desires of the individual. In this manner, process automation can be introduced in an incremental, bottom-up fashion into the organization. Incremental development can be based on rules that are reasonably small in scope.

Over time, each individual user will accumulate a library of rules. Some rules will have been created by the user, while other rules will have been generated by other users. In a collaborative environment, rules will proliferate amongst the users as the value of particular rules become apparent. Rule sharing will therefore enable the rapid development of an automation tool database that can be flexibly applied to particular use scenarios.

Once a sizable number of rules are created, a user will want to organize them in some fashion. In one embodiment, a ruleset system object is provided. The ruleset contains system object references to rule and ruleset system objects. The ruleset can then be bound to event sources in a manner similar to the binding of a rule to event sources. This means that all the rules in the ruleset would be evaluated in the context provided by the event source.

In general, rules and rulesets are not useful unless they are associated with one or more event sources. This process is called binding and creates an automation association between the rule/ruleset and an event source.

The automation association between the rule/ruleset and the event source represents a relationship between system objects where the system objects are not necessarily organized hierarchically. This form of general association is based on a system object reference, which is in essence a handle, or soft link from one of the system objects in the association to the other system object in the association.

In general, automation binding is used to indicate which rules are applicable to the event source and hold for each rule, event source pair. Binding a rule to an event source sets the rule to listen for events from that event source. Binding a ruleset to an event source sets up all member element rules in the ruleset to listen for events from that event source.

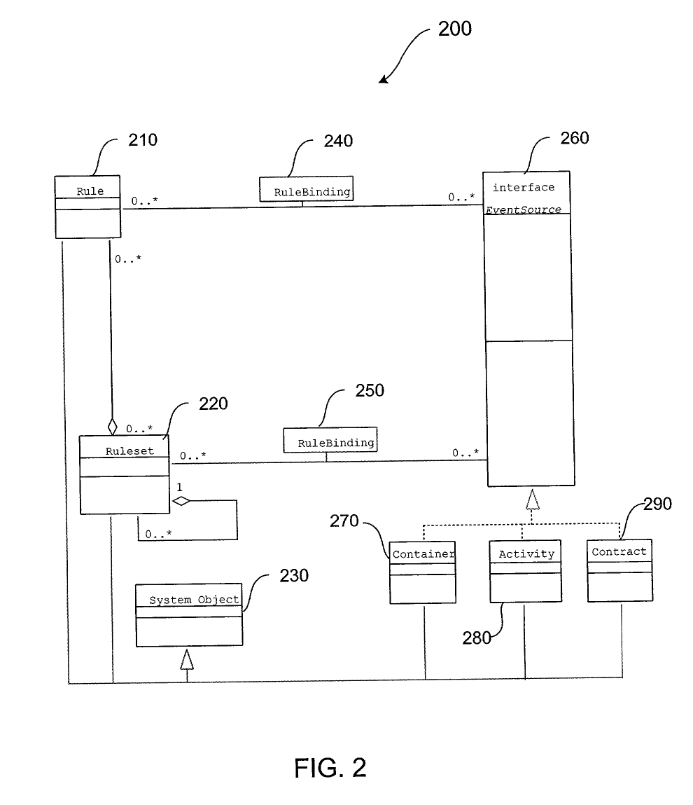

An illustration of the association between rules and event sources is illustrated in FIG. 2, which demonstrates how automation system objects relate to other system objects. As illustrated, rule 210 is bound to an event source 260 via rule binding 240. In the illustrated embodiment, event source 260 can be a container 270, an activity 280, or a contract 290. Each of container 270, activity 280, and contract 290 are specific types of system objects 230. In a similar manner, ruleset 220 is bound to event source 260 via rule binding 250. Ruleset 220 is itself a group of rules 210 and rulesets 220. It should be noted that while not shown, a rule can also be bound to an event timer.

In one embodiment, rule object 210 includes the attributes listed in Table 3. These attributes can be defined in the context of a user interface that enables a user to create or edit a rule.

TABLE 3

| Attribute | Description |
|---|---|
| Name | The name of the rule |
| Description | A description of the rule's intent. |
| Digest | A system generated summary of the Rule |
| | Definition. |
| Rule | Contains the ECA components of the rule. |
| Definition | |

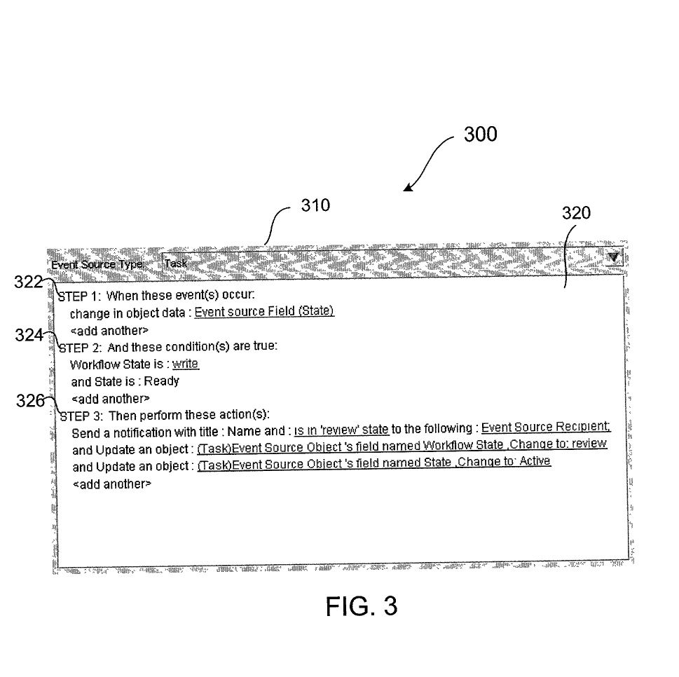

An example of a portion of a rule definition user interface screen 300 is provided in FIG. 3. User interface screen 300 includes an event source type field 310 and a rule definition section 320. Event source type field 310 indicates that a rule definition is being prepared for a “Task” activity event source. Rule definition section 320 further includes event, condition, and action component sections 322, 324, 326, respectively.

Event component section 322 is used to specify a particular event generated by the event source. In the example of FIG. 3, the specified event is based on a system object attribute change trigger that identifies a change in the State attribute for the Task activity. In this example, assume that the task also has a Workflow State attribute that includes states such as outline, write, review, edit, and complete.

Condition component section 324 specifies two conditions to be evaluated upon detection of a change in the State attribute of the Task. First, it is determined whether the Workflow State attribute is in the “write” state. Second, it is determined whether the State attribute is in the “Ready” state. In effect, these two conditions are used to determine the point in time at which a document, that is being prepared in the Write state of a workflow, is ready to be reviewed. If both of these conditions evaluate to True (i.e., logical AND), then the specified rule actions would be initiated.

It should be noted that while condition component section 324 can include a set of terms that each potentially evaluate to true or false, a statically true condition can also be specified. This statically true condition would ensure that the occurrence of the event specified in event component section 322 would always lead to the initiation of the specified rule actions specified in action component section 326.

Action component section 326 is used to specify the rule actions that are to be performed upon the satisfaction of the conditions in condition component section 324. In the example of FIG. 3, three different actions are specified. First, a notification action is provided that is designed to notify a recipient of the task deliverable that the Workflow State attribute has changed to a value of “review.” Second, an update action is provided that is designed to change the Workflow State attribute of the Task object to a value of “review.” Finally, a second update action is provided that is designed to change the State attribute of the Task object to a value of “Active.” In combination, these actions automatically provide status information to a future receiver of the task deliverable and update the status attributes of the Task object.

After the rule is defined, it can be stored in a rules repository either locally or in a centralized location. In one embodiment, a listing of defined rules would be displayed in a user interface that enables a user to create associations between rules and other system objects (e.g., container, activity, contracts). The creation of associations by the users serves to implement the desired automation into the system.

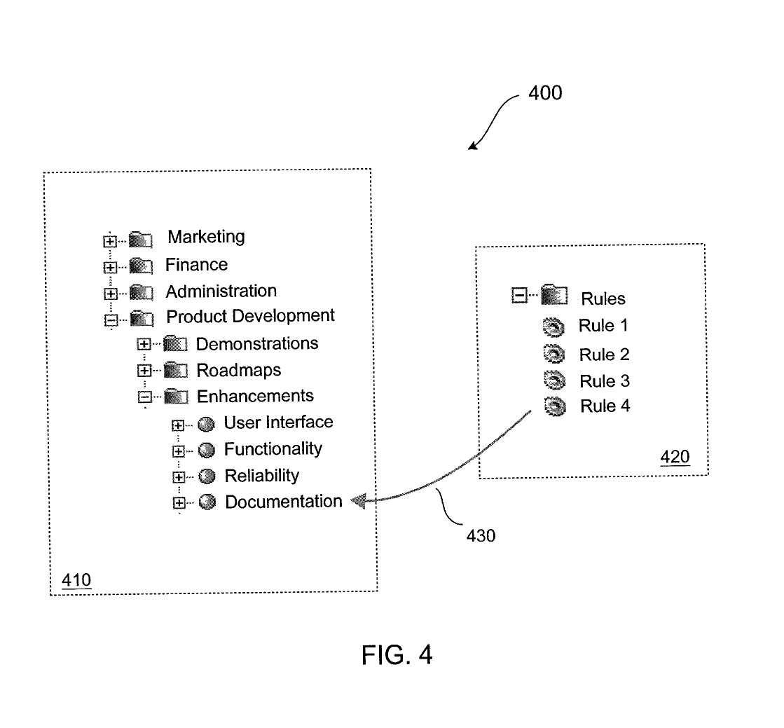

An embodiment of a user interface that enables the binding of rules to other system objects is illustrated in FIG. 4. User interface screen 400 includes two user interface screen portions 410, 420. User interface screen portion 410 includes a hierarchical structure of folder objects, thereby organizing ongoing work within the organization. Within the “Enhancements” folder of the “Product Development” folder is a listing of tasks. These tasks include User Interface, Functionality, Reliability, and Documentation tasks.

User interface screen portion 420 includes a Rules folder. The Rules folder includes a listing of four rules that have been generated. A rule within the Rule folder of user interface screen portion 420 may be bound to a task (or other suitable system object) by dragging the particular rule icon to the particular task. In the example of FIG. 4, the icon of Rule 4 can be dragged to the Documentation task over path 430. Upon completion of this dragging motion, Rule 4 is bound to the Documentation task and becomes a listener of the events that are generated by the Documentation task. It should be noted that user interface screen 400 can also be used to bind rulesets to particular system objects. In the context of the embodiment of FIG. 4, the ruleset could be represented by a distinctive icon within Rules folder 420.

It should be noted that binding of rules or rulesets to system objects is a function of association creation. Accordingly, other user interface mechanisms can be designed to facilitate an association of particular rules to particular system objects. For example, pop-up windows that are generated on a right-mouse click can be used to select one or more rules to be associated with a particular system object.

In one embodiment, association creation can be enabled automatically through personal rule bindings. Personal rule bindings enable customization of the rules that are automatically associated with a particular system object once an individual is associated with that system object. In general, these personal rule bindings can be dependent on the type of system object, the role of the user, or any other variable that defines a relationship between the user and the system object.

In one example, a user can define a first set of rules that are to be automatically associated with any task activity that the user is associated with, and a second set of rules that are to be automatically associated with any project activity that the user is associated with. In another example, a user can define a third set of rules that are to be automatically associated with any system object in which the user is taking on the role of point of contact, and a fourth set of rules that are to be automatically associated with any system object in which the user is taking on the role of an interested observer.

As would be appreciated, these examples are not intended to be exhaustive. Rather, these examples have been provided to illustrate the benefits of personal rule bindings in providing an efficient mechanism of creating associations between rules and system objects. This efficiency is naturally suited for situations where repeated instances of particular user-object relationships can be defined.

It should be noted that, rules and rulesets that are bound to system objects operate under the authority of the user that created the association. In other words, the user attributed with the association creation is able to maintain a virtual presence in the system through the rules and rulesets that operate under his authority. In one embodiment, the rules and rulesets therefore include a security credential associated with the user attributed with the association creation. This security credential provides the appropriate permission for the operation of the rules and rulesets within the defined security framework. As would be appreciated, the specific type of security credential is implementation dependent. In one embodiment, the security credential is the user ID.

As thus described, rules represent a basic building block upon which process automation can be developed. These building blocks can be defined by individual users to address their particular automation needs. In this manner, process automation is introduced in an incremental, bottom-up fashion into the organization.

Process automation can also be achieved in an incremental, bottom-up fashion through the creation of workflow activities. As noted above, workflow activities represent activities that have pre-defined workflows and processes associated with them. Workflow activities can be used to automate both simple and complex workflows. For example, workflows can be defined to govern a process for proper review and distribution of draft and final versions of system documentation.

In general, workflow activities enable users to configure and automate activities that include a series of steps and decision points. Workflow activities can also perform a number of automation functions based on events and conditions that occur in the system. A user interface enables users to define a workflow that includes a series of steps as well as conditions for progressing through the series of steps. Portions of the workflow (e.g., notifications, form completion, etc.) can also be automated.

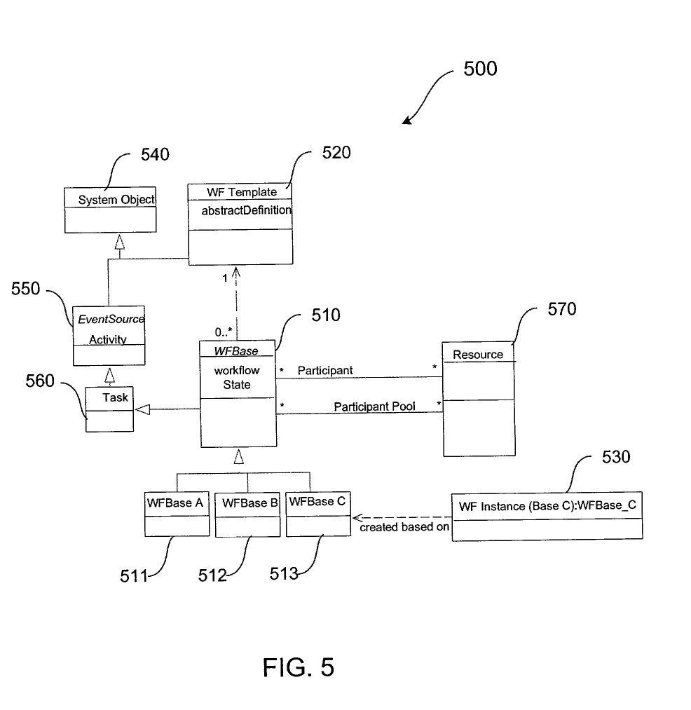

In one embodiment, a workflow activity is based on a workflow (WF) Base element (a data template), a WF Template element (a behavior template), and a WF Instance element (an actual deliverable/piece of work). The relationship between the WF Base element, the WF Template element, and the WF Instance element is demonstrated in FIG. 5, which illustrates workflow activity domain model 500.

WF Base 510 is a conceptual component that supports multiple schemas for WF Instances. WF Base 510 functions as a schema template for a future WF Instance system object 530. There is a separate WF Base type 521-523 for each WF Instance 530.

In general, WF Instance 530 is the behavior wrapper for an actual deliverable. It is a system object with the same schema as a particular WF Base 521-523 and follows the workflow behavior specified by WF template 520. WF Instances 530 are created by users to provide guidance and automation during the work required to produce a deliverable. WF Instances 530 are generally created on an ad hoc basis.

As noted, each WF Instance 530 maps directly to one VVF Base type 521-523. While WF Instances 530 are the system objects created by users, the WF Base 510 determines the schema and any relationships the WF Instance 530 can participate in.

WF Base 510 provides a framework on which a workflow can be placed. Fields are customized to support the specific problem or deliverable being modeled by the workflow activity. WF Base 510 is a template for the data within a workflow activity. WF Base 510 is not generally visible to the user.

WF Base 510 is based on a task system object schema that is illustrated in FIG. 5, shown through the relationship of system object 540, activity object 550, and task object 560. WF Instances 530 created from a WF Base type 521-523 have both the task system object schema and behavior. In one embodiment, WF base 510 includes the activity attributes provided in Table 4.

TABLE 4

| Attribute | Description |
|---|---|
| Name | Title of the Activity |
| Description | Text that further details the activity |
| Duration | The number of work days required to complete an |
| | activity |
| Effort | Number of hours expected to complete the activity |
| Due Date | The expected completion date of the activity |
| Start Date | The date work is to begin on an activity. |
| End Date | The system determined end date of an activity |
| Date Calculation | Indicates how Start and End Dates are Calculated. |
| Mode | |
| Percent Complete | Percentage of activity work completed |
| Percent Complete | The user entered representation of the method used to |
| Calculation Mode | calculate percent complete for this activity |
| Priority | The emphasis placed on completion of this activity |
| | (e.g., high, medium, low) |
| Confidence Level | The likelihood that a user believes the activity will be |
| | completed on time (e.g., high, medium, low) |
| Activity State | The current workability of the activity (e.g., blocked, |
| | issue, ready, active, completed, abandoned) |
| Activity Status | The overall health of the activity (e.g., on time, |
| | possible slip, late) |
| Dialog | Persistent Message Forum |

In addition to the activity attributes of Table 4, WF Base 510 has the Activity attributes of Table 3 as well as the additional workflow-related attributes of Table 6.

TABLE 5

| Attribute | Description |
|---|---|
| Workflow State | The workflow state contains the name of the current state |
| | that the workflow is in. |
| WF Source | A reference to the template that this workflow activity is |
| Template | an instantiation of. |

WF Template 520 is a system object that includes the description of how a specific type of work or deliverable is produced. It specifies the workflow (and its component states and the flows between states), roles, and rules used for action automation. A WF Template 530 is a general description applicable to all instances of the work or deliverable and uses a specific WF Base (schema). WF Template 520 is a “behavior template” that can be created and modified by individual users. A WF Template 520 should exist before any workflow activities can be instantiated.

In one embodiment, a workflow specification includes, for each state in the workflow, the information of Table 6.

TABLE 6

| State Information | Description |
|---|---|
| Name | Name for the workflow state |
| Description | Instructions to the participants for the state |
| Participant Bindings | Participants for the state |
| Rules/Rulesets | Automation actions |
| Exit Criteria | Allows the workflow to enforce certain conditions |
| | before a transition can occur |
| Next State | Explicit state name or decision point details |

In general, Participant Bindings represent the binding of a workflow state to a resource 570 (see FIG. 5). In this framework, the Participant Pool set is the union of all responsible parties for all states in the workflow.

In one embodiment, resources 570 can include users, roles, and teams, each of which can be assigned to activities, receive notifications, and otherwise interact with the system. It should be noted that resources 570 can also represent inanimate objects as well. As the workflow activity participants represent those resources 570 that are responsible for the workflow activity during a particular state, the participants member set (i.e., the Resources working on the workflow activity) can change on a per workflow state basis.

In general, a team provides information about a group of users bound together for some common cause. That cause could be organizational (i.e. common manager), role related (common type of work), task related (common deliverable), or other cause (e.g. common location, etc.). Teams enable the assignment of entire groups of users to activities and rules. Teams also enable the description of the organizational structure of the user community.

Roles, on the other hand, represent a mechanism for assigning work items and automation actions to users indirectly. Roles are useful to help convey responsibility, and ease automation configuration. Roles are significant in that they may be assigned as participants to activities and rules and then resolved to an actual user independently within various scopes of the organization. For example the quality assurance (QA) representative for Project X may be Sue, while that same role for Project Y may be Fred. One set of rules and rule actions from the corporate handbook that pertain to a project's QA representative can thus be applied to tasks in both projects without need for change.

In one embodiment, resource assignments to workflow activities are enabled through the use of local scope roles called workflow actors (WAs). WAs provide various benefits to workflow activities, including support of WF Template 520 re-use, simplification of the process of creating WF Instances 530, provision of relevant interaction details to resources assigned to WF Instances 530, and abstraction of users from the details of WF Template 520 that do not apply to the user's interaction with WF Instances 530.

In general, WAs are declared in WF Template 520 and can be associated with one or more workflow activity states. A WA's scope is the WF Template 520 and hence any instantiated WF Instances 530. Thus, a WF Instance 530 can only access the WAs declared in that WF Template 520.

WAs are resolved to resources on a per WF Instance basis, generally at “instantiation time”. In one embodiment, WAs can support multiple resolutions, thereby enabling a WA to resolve to a list of one or more resources.

In one embodiment, a WA includes Name and Description attributes. The Name attribute is the name that is used within WF Template 520 and displayed to the user. This Name must be unique within a given WF Template 520. The Description attribute contains an overall description of the WA. This description can be designed to provide enough information to allow the instantiator of the workflow activity to resolve the WA to the appropriate resource(s) and also to describe WA's responsibilities in each of the workflow activity states to which it is assigned.

Finally, WAs can also be referenced by rules/rulesets that are built against WF Template 520.

In general, Rules/Rulesets for a workflow state enable automation actions to be incorporated into the workflow. As described above, rules can be based on events and conditions that occur in the system. As defined for a particular workflow state, rules/rulesets can be used in a variety of ways. In a simple example, a rule can be used to simply notify a resource that a workflow state deliverable has been completed. More generally, a rule/ruleset can be used in the process for producing the deliverable within the workflow state itself (e.g., form completion, document forwarding, status alerts, etc.).

Exit Criteria for a workflow state generally refers to a mechanism designed to generate information to be used for the determination of a possible state change. In one embodiment, the exit criteria is modeled as a set of questions, each of which resolves to a boolean result. More generally, the exit criteria can include rule-type conditions that can be evaluated on the WF instance to automatically generate information to be used for the determination of a possible state change.

Exit Criteria generally allows the workflow to enforce certain conditions before a state transition can occur. Defined exit criteria should be evaluated on attempted exit transitions from a workflow state to contiguous next states. Exit criteria can be completely automated, completely user driven or a combination of both. Automated exit criteria should support arbitrary conditions on the workflow activity attributes and need not require any user data to be entered at evaluation time. User-driven exit criteria, on the other hand, can offer users questions that can be evaluated to a boolean result. For example, simple yes/no type questions can be supported. The various exit criteria can be logically combined to produce a final exit criteria response.

As noted in Table 6, workflow state information also includes Next State information. Next State information can be either an explicit state name or decision point details. An explicit name would provide the identity of the next state once the exit criteria have been satisfied.

A decision point, on the other hand, is modeled as a set of possible target states (Target Set) from which the next state can be chosen from. Decision points can be completely automated, completely user driven or a combination of both. Automated decision points should support arbitrary conditions on the workflow activity attributes and should not require any user data to be entered at evaluation time. User-driven decision points, on the other hand, may offer users questions that can be evaluated to resolve exactly one out of many potential destination states.

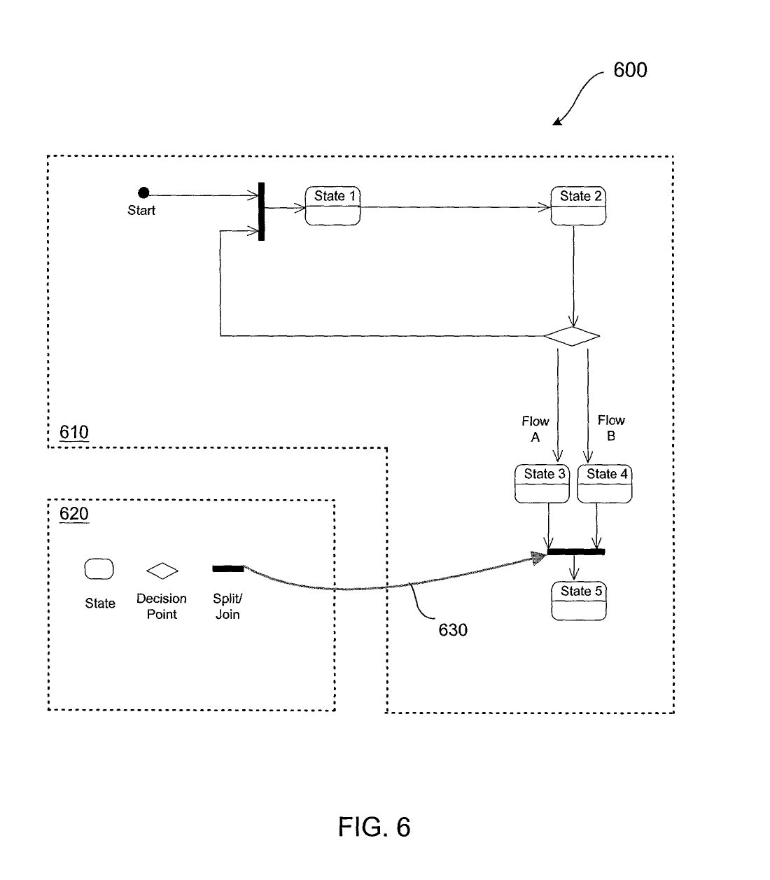

In one embodiment, workflows can be specified using a graphical user interface. FIG. 6 illustrates an embodiment of a user interface screen 600, which enables the specification of workflow states and transitions. User interface screen 600 includes a workflow display portion 610 and a workflow component section 620.

Workflow component section 620 includes a listing of workflow components that can be used to create a workflow specification. In the illustrated embodiment of FIG. 6, the workflow component listing includes state, decision point, and split/join components. Selected workflow components can be used to create a workflow by “dragging and dropping” components into the workflow display portion 610. For example, FIG. 6 illustrates the “dragging and dropping” of a join component into workflow display portion 610 using path 630.

As would be appreciated, workflow component section 620 can be designed to include a variety of additional workflow components (e.g., resource or rule components). The specific selection of components in workflow component section 620 would be dependent on the level of specificity desired at the graphical-construction level. In one embodiment, workflow component specifications can be defined by the user through pop-up forms or other interface mechanisms that enable a direct or indirect specification of a portion of the workflow.

The workflow that is displayed in workflow display portion 610 represents one example of a possible workflow construction. The workflow as defined includes states, decision points (which allow iterations and OR-splits), iterations (repeating a sequence of component states), OR-splits (single flow segment splits into two or more mutually exclusive segments), and OR-joins (two or more flow segments join to become one).

In one example, a state can be used to represent an activity (e.g., task), the completion of which would lead to a transition to a next state. The exit criteria, participants, rules, etc. for that particular state can be defined, for example, by filling in one or more forms that are presented to the user when the state icon is selected.

As described above, more than one potential next states can exist. In this case, a decision point would need to be defined to enable selection of the actual next state. The conditions for the particular decision point can also be defined, for example, by filling in one or more forms that are presented to the user when the decision point icon is selected.

As thus described, the workflow specification can be generated and customized using the features of a particular user interface. Workflow activities that have been created by a user can also be shared with other users, thereby encouraging rapid adoption of “best practices.” This proliferation of workflow activities also helps ensure consistency in the process execution across the organization.

For example, workflow activities can be assigned by team leaders to team members (or by users to themselves) in a manner similar to the assignment of any task. In this environment, workflow activities can be sent to a user and displayed in that user's task manager in a manner similar to an email or task listing (e.g., Microsoft Outlook listing).

Unlike conventional static tasks, workflow activities represent tasks having associated workflow behavior. The only interaction with a conventional static task is a user's designation of completion of the static task (e.g., checkbox selection that removes the task from the task manager). With workflow activities, on the other hand, satisfaction of one or more conditions (e.g., completion of a draft document) can be required to advance a workflow activity to the next state in the workflow. Thus, workflow activities cannot be designated as complete until each step in the workflow has been completed.

In general, the status of the uncompleted workflow activity can also be reported to interested parties (e.g., team leaders). These status reports can be designed to provide an indication of the extent to which the workflow activity has been completed. This status reporting is significantly more valuable as compared to the binary status information (completed/not completed) of a static task.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

[image]

[image]

[image]

[image]

[image]

What is claimed is:

1. A method for enabling work automation, comprising:
displaying a first user interface that enables a user to define an automation rule, said automation rule including a specification of an event and an action; and
displaying a second user interface that enables a user to bind said automation rule to an event source, said binding enabling said automation rule to listen for events generated by said event source, wherein upon an occurrence of said event said action is carried out.

2. The method of claim 1, wherein said event is one of a system object attribute change, a system object association change, a timer expiration, a system object delete, a problem domain specific event, and an external event.

3. The method of claim 1, wherein said automation rule further includes a specification of a condition.

4. The method of claim 1, wherein said action is one of a create, update, bind, unbind, copy, execute, and notify actions.

5. The method of claim 1, wherein said event source is one of an activity, container, contract, resource and external system.

6. A method for enabling work automation, comprising:
defining an automation rule, said automation rule including a specification of an event and an action;
binding said automation rule to a first event source such that said automation rule listens for events generated by said first event source; and
binding said automation rule to a second event source such that said automation rule listens for events generated by said second event source,
wherein at least part of a behavior of said automation rule is defined by a particular event source to which it is bound.

7. The method of claim 6, wherein said events include a system object attribute change, a system object association change, a timer expiration, a system object delete, problem domain specific event, and an external event.

8. The method of claim 6, wherein said automation rule further includes a specification of a condition.

9. The method of claim 6, wherein said action is one of a create, update, bind, unbind, copy, execute, and notify actions.

10. The method of claim 6, wherein said event source is one of an activity, container, contract, resource and external system.

11. A user interface that enables work automation, said user interface comprising:
a first interface portion that is configured to enable selection of an automation rule, said automation rule including a specification of an event and an action; and
a second interface portion that is configured to display an event source icon that is associated with an event source,
wherein said user interface enables a user-controlled action of creating an association between said selected automation rule and said event source associated with said event source icon in said second interface portion, said user-controlled action initiating a binding of said automation rule to said event source, thereby enabling said automation rule to listen for events generated by said event source, wherein upon an occurrence of said event said action is carried out.

12. The user interface of claim 11, wherein said first interface portion includes a rule icon that is associated with said automation rule, said rule icon capable of being dragged to said event source icon.

13. The user interface of claim 11, wherein said first interface portion is a pop-up window.

14. The user interface of claim 11, wherein said event is one of a system object attribute change, a system object association change, a timer expiration, a system object delete, a problem domain specific event, and an external event.

15. The user interface of claim 11, wherein said automation rule further includes a specification of a condition.

16. The user interface of claim 11, wherein said action is one of a create, update, bind, unbind, copy, execute, and notify actions.

17. The user interface of claim 11, wherein said event source is one of an activity, container, contract, resource and external system.

18. A computer program product, comprising:
computer-readable program code for causing a computer to display a first user interface that enables a user to define an automation rule, said automation rule including a specification of an event and an action;
computer-readable program code for causing a computer to display a second user interface that enables a user to bind said automation rule to an event source, said binding enabling said automation rule to listen for events generated by said event source, wherein upon an occurrence of said event said action is carried out; and
a computer-usable medium configured to store the computer-readable program codes.

19. A computer program product, comprising: computer-readable program code for causing a computer to define an automation rule, said automation rule including a specification of an event and an action;
computer-readable program code for causing a computer to bind said automation rule to a first event source such that said automation rule listens for events generated by said first event source;
computer-readable program code for causing a computer to bind said automation rule to a second event source such that said automation rule listens for events generated by said second event source,
wherein at least part of a behavior of said automation rule is defined by a particular event source to which it is bound; and
a computer-usable medium configured to store the computer-readable program codes.

20. A method for enabling work automation, comprising:
defining a portable automation rule, said portable automation rule including a specification of an event and an action; and
storing said defined portable automation rule in a rule repository, wherein said defined portable automation rule is capable of being individually bound to a plurality of event sources.

21. The method of claim 20, wherein said event includes one of a system object attribute change, a system object association change, a timer expiration, a system object delete, a problem domain specific event, and an external event.

22. The method of claim 20, wherein said automation rule further includes a specification of a condition.

23. The method of claim 20, wherein said action is one of a create, update, bind, unbind, copy, execute, and notify actions.

24. The method of claim 20, wherein an event source is one of an activity, container, contract, resource and external system.

25. A method for enabling work automation, comprising:
defining a workflow activity, said defined workflow activity including a series of steps and conditions for progressing through said series of steps; and
assigning said workflow activity from a workflow activity assignor to a workflow activity recipient, said workflow activity capable of being represented by an icon on a computer display of said workflow activity recipient.

26. The method of claim 25, wherein said workflow activity further comprises an automation function that is responsive to events and conditions.

27. A method for enabling work automation, comprising:
defining a portable workflow activity, said defined portable workflow activity including a series of steps and conditions for progressing through said series of steps; and
assigning said portable workflow activity from a workflow activity assignor to a workflow activity recipient, wherein at least part of a behavior of said assigned portable workflow activity is dependent on an environment in which said portable workflow activity operates.

28. The method of claim 27, wherein said workflow activity further comprises an automation function that is responsive to events and conditions.

29. A method for enabling work automation, comprising:
storing a personal rule binding that has been defined by a user, said personal rule binding identifying one or more automation rules that are to be automatically associated with a system object upon the creation of a particular user-object relationship;
determining whether an association of a user to a particular object matches said user-object relationship definition associated with said personal rule binding; and
upon said determination, binding said one or more automation rules to said particular object, thereby enabling said one or more automation rules to listens for events generated by said particular object.

30. The method of claim 29, wherein said user-object relationship identifies a particular object that said user is associated with.

31. The method of claim 29, wherein said user-object relationship identifies a particular role for said user.
